(19) United States
(12) Patent Application Publication
(10) Pub. No.: US 2001/0052572 A1
(43) Pub. Date: Dec. 20, 2001

(54) Directivity-type radiation detecting apparatus

(76) Inventors: Satoshi Mikami, Naka-gun (JP); Hirohide Kobayashi, Naka-gun (JP); Mitsuru Kamei, Mito-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/879,124

(22) Filed: Jun. 13, 2001

(30) Foreign Application Priority Data
Jun. 19, 2000 (JP) 2000-182962

(51) Int. Cl. G01T 1/00

(52) U.S. Cl. 250/394

(57) ABSTRACT

A directivity-type radiation detecting apparatus capable of detecting a particular radiation source or a moving situation thereof even in the high radiation atmosphere. A multiplicity of radiation detector probes are dispersedly arranged in different directions on an outer surface of a radiation shield. Alternatively, a multiplicity of penetration holes are dispersedly formed in different directions in a shell-shaped radiation shield and radiation detector probes are respectively disposed in the penetration holes of the radiation shield. The above-described directivity-type radiation detecting apparatus is used to compute and process a position and a direction of each radiation detector probe and a value measured by each radiation detector probe, whereby a position, a distribution situation or a moving situation of a radiation source is detected.

### BACKGROUND OF THE INVENTION

The present invention relates to a directivity-type radiation detecting apparatus capable of determining a direction in which a radiation ray comes by separately and dispersedly arranging a plurality of radiation detector probes. This art is useful, for example, for a case of selectively measuring particular radioactivity (radiation ray) in a high radioactive atmosphere or detecting a distribution situation or a moving situation of a radiation source.

In various research facilities or nuclear reactor facilities dealing with radioactive substances, it is important to maintain below a reference value a radioactive level or pollution level due to radioactive substances in operation environment in order to conduct operation safely. For this reason, there is a necessity to accurately measure radiation ray. Objectives of radiation measurement are the kind of radiation, energy distribution thereof and the like.

The prior art has attempted to detect all the radiation rays in the atmosphere. In line with this policy, structural development in a radiation detecting apparatus has progressed exclusively in order to enable measurement with possible efficiency. As the radiation detector, a scintillation detector, a semiconductor detector or the like has been used.

However, because the conventional radiation detecting apparatus is designed to detect all the radiation rays in the atmosphere as described above, it is difficult to recognize a position of a radiation source. Also, it is difficult to monitor a moving situation of a radiation source and specify another radiation source brought in a radiation atmosphere.

### SUMMARY OF THE INVENTION

It is an object of the present invention to provide a directivity-type radiation detecting apparatus capable of detecting a particular radiation source or a moving situation thereof even in the high radiation atmosphere.

The present invention is a directivity-type radiation detecting apparatus in which a multiplicity of radiation detector probes are dispersedly arranged in different directions on an outer surface of a radiation shield. It is not always required that all of the radiation detector probes are directed to different directions. At least a part of the detector probes are arranged in different directions. The radiation shield preferably has an outer surface in a cylindrical surface form, a spherical surface form or a polygonal cylindrical surface form or has an outer surface of a part thereof.

Also, the present invention is a radiation detecting apparatus in which a multiplicity of penetration holes are dispersedly formed in different directions in a shell-shaped radiation shield and radiation detector probes are respectively disposed in the penetration holes of the radiation shield. It is not always required that all of the penetration holes are formed so as to be directed to different directions. At least a part of the penetration holes are be formed in different directions. Also in this case, the radiation shield preferably has an outer surface in a cylindrical surface form, a spherical surface form or a polygonal cylindrical surface form or has an outer surface of a part thereof.

Furthermore, the present invention is a radiation detecting system in which the directivity-type radiation detecting apparatus as described above is used to compute and process a position and a direction of each radiation detector probe and a value measured by each radiation detector probe, whereby a position, a distribution situation or a moving situation of a radiation source is detected.

### BRIEF DESCRIPTION OF THE DRAWINGS

FIGS. 1A and 1B are explanatory views showing an embodiment of a directivity-type radiation detecting apparatus according to the present invention.

FIGS. 2A and 2B are explanatory views showing another embodiment of a directivity-type radiation detecting apparatus according to the present invention.

FIG. 3 is an explanatory view showing still another embodiment of a directivity-type radiation detecting apparatus according to the present invention.

FIG. 4 is an explanatory view showing yet another embodiment of a directivity-type radiation detecting apparatus according to the present invention.

FIG. 5 is an explanatory view showing an example of an installation situation of a directivity-type radiation detecting apparatus according to the present invention.

FIG. 6 is an explanatory view showing another example of an installation situation of a directivity-type radiation detecting apparatus according to the present invention.

FIG. 7 is an explanatory view showing an example wherein a directivity-type radiation detecting apparatus according to the present invention is mounted on a monitor robot.

### PREFERRED EMBODIMENTS OF THE INVENTION

A radiation detector probe used in the present invention depends upon the kind of a radiation ray. For the most popular γ-ray, a semiconductor detector is best suited. This is because of the reason that the semiconductor detector is compact and to be disposed comparatively freely. For example, there is easily used a semiconductor detector having a shape with a diameter of 10-20 mm and a thickness of approximately 3 mm or smaller and for use at normal temperature. The semiconductor detector is completely enclosed by plastic or the like and has a structure provided with a power supply terminal and an output terminal.

A radiation shield used in the present invention is also different depending on the kind of a radiation ray. In a directivity-type radiation detecting apparatus according to the present invention, the radiation ray assumed to be detected is principally γ ray and neutron ray. It is proper that for the case of a γ ray the radiation shield uses lead, while for the case of a neutron ray the radiation shield uses liquid paraffin. Incidentally, in the case where a semiconductor detector for γ ray is used in detecting a neutron ray, there is a need of previously applying a fissile material such as uranium around the radiation detector probe. This is because of the reason that the neutron ray causes fission reaction and the resulting fission product element emits a γ ray so that the γ ray is detected by the γ ray semiconductor detector. Accordingly, it is possible to utilize the directivity-type radiation detecting apparatus for both γ ray and neutron ray. In such a case, the radiation shield uses both lead and liquid paraffin.

The radiation detector probes are arranged on an outer surface of the radiation shield or disposed deep in penetration holes formed in the radiation shield. Where the radiation detector probe is attached on the outer surface of the radiation shield, there is an advantage of widening the field of measurement. The radiation detector probe disposed deep in the penetration hole formed in the radiation shield is advantageous in accurately determining a location of a radiation source.

Since the apparatus of the present invention can detect a movement of a radiation source by computing and processing measured values of a multiplicity of radiation detector probes, it is possible to detect loss, theft, abnormality during movement of the radiation source in an early stage to prevent accident and disaster in advance. Also, because the present invention can selectively measure a particular radiation source even in a high radiation atmosphere, it is useful for monitoring storage and movement of radioactive substance in a controlled area, a hot cell or a globe box. Also, since the apparatus of the present invention is suitable for remote monitor, radiation exposure level can be greatly reduced in addition to labor saving, thus useful in nuclear material control.

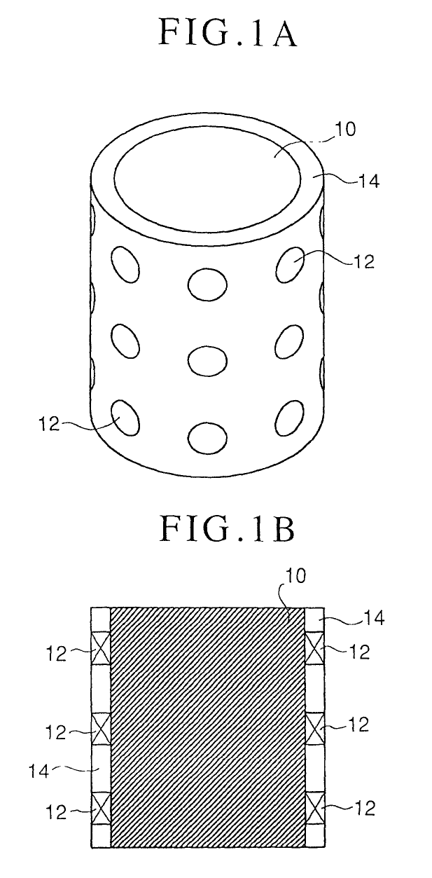

FIGS. 1A and 1B are explanatory views showing an example of a directivity-type radiation detecting apparatus according to the present invention, wherein FIG. 1A is a perspective view and FIG. 1B is a vertical sectional view thereof. On an outer surface of a cylindrical radiation shield 10 (made of lead herein on the assumption of a γ ray as a radiation ray), there are dispersedly arranged a plurality of radiation detector probes 12 so as to be directed to different directions. Although the provision of the radiation detector probes 12 herein is eight in the number by three stages, the number and position of arrangement may be properly changed depending upon a situation of detection. Each radiation detector probe 12 detects a radiation ray coming to the detection surface of the detector probe, while a radiation ray from the opposite side is shielded by the radiation shield 10 and hence not detected. Functionally, the radiation detector probe 12 may be exposed at the outer surface of the radiation shield 10. However, actually a protection member 14 in which the radiation detector probes 12 just fit is provided in order to provide protection for the radiation detector probes 12 and favorable appearance thereof.

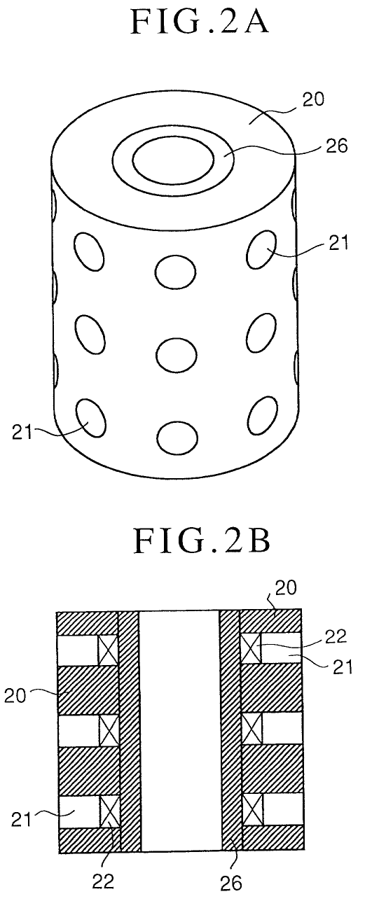

FIGS. 2A and 2B are explanatory views showing another embodiment of a directivity-type radiation detecting apparatus according to the present invention, wherein FIG. 2A is a perspective view and FIG. 2B is a vertical sectional view thereof. In a tubular radiation shield 20 (made of lead herein on the assumption of a γ ray as a radiation ray), there are dispersedly formed a plurality of penetration holes 21 so as to be directed to different directions. Radiation detector probes 22 are disposed in the penetration holes 21 from the inside of the radiation shield 20. Although the provision of the penetration holes 21 herein is eight in the number by three stages, the number and position of arrangement may be properly changed depending upon a situation of detection. Another tubular radiation shield 26 may be provided inside the radiation shield 20, as required. Each radiation detector probe 22 detects a radiation ray coming through the penetration hole 21 to the detection surface of the detector prove.

The penetration hole 21 formed in the radiation shield 20 plays a role of a collimator function to delimit an incident direction of a radiation ray. The radiation shield 26 at the inner side plays a role to shield a radiation ray from the opposite side. This structure is effective for measuring a limited radiation ray, and effective in the case of carrying out various operations with a radiation source fixed or radiation monitor during storage.

In these structures, a semiconductor detector is preferred as the radiation detector probe 12, 22 because of the reason of small in size and easy to arrange or dispose as described hereinbefore. The arrangement of the radiation detector probes as shown in FIGS. 1A and 1B widens the field of measurement of one radiation detector probe. However, in order to determine an accurate position of a radiation source, there is a need of gathering detection results from a multiplicity of radiation detector probes, and computing and processing the gathered detection results. On the contrary, the arrangement of the radiation detector probes as shown in FIGS. 2A and 2B narrows the field of measurement of one radiation detector probe, which is advantageous for determining an accurate position of a radiation source but requires a multiplicity of radiation detector probes. In any way, there is a necessity of determining an arrangement situation and the number of radiation detector probes to be arranged by taking detection range and measurement accuracy into consideration.

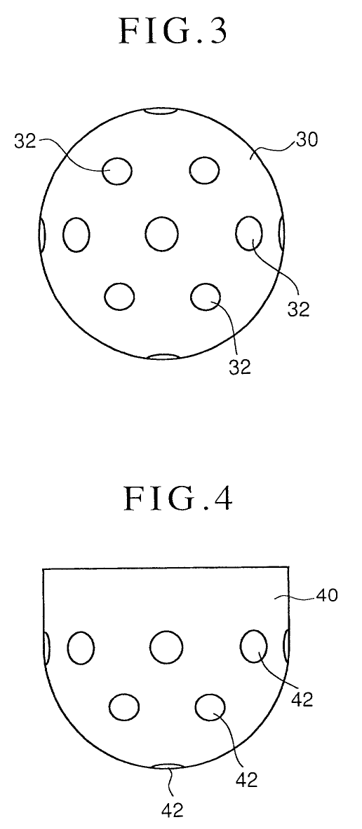

FIG. 3 and FIG. 4 are explanatory views showing still another embodiment of a directivity-type radiation detecting apparatus according to the present invention. FIG. 3 shows a structure having a multiplicity of radiation detector probes 32 dispersedly arranged on an outer peripheral surface of a spherical radiation shield 30. FIG. 4 shows a structure having a multiplicity of radiation detector probes 42 dispersedly arranged on an outer peripheral surface of a semi-spherical radiation shield 40. In any case, a spherical shell structure or semi-spherical shell structure of radiation shield may be used to provide a structure in which a multiplicity of penetration holes are dispersedly formed and radiation detector probes are disposed in the penetration holes as shown in FIGS. 2A and 2B. These are effective for the case that a radiation source exists also in the ceiling or also on the floor.

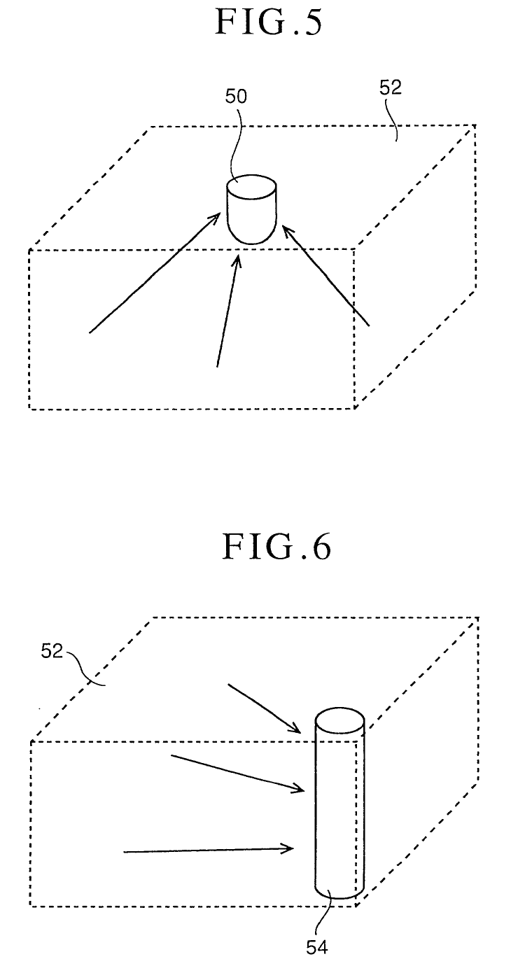

FIG. 5 and FIG. 6 show installation examples of the directive-type radiation detecting apparatus. FIG. 5 is an example of installation in a controlled area such as a laboratory, a storage room or a hot cell. In these cases, it is preferred to provide arrangement that the radiation rays in every direction within the controlled area are allowed to be incident on the detecting apparatus. Accordingly, a semi-spherical directivity-type radiation detecting apparatus 50 as shown in FIG. 4 is installed in a ceiling center of the controlled area 52. FIG. 6 is an example in which a cylindrical directivity-type radiation detecting apparatus 54 is installed at a corner of a laboratory 52 in a controlled area. Of course, there may be employed a structure in which a multiplicity of radiation detector probes are dispersedly arranged on a curved-surface portion of a columnar radiation shield having a fan-shaped cross section. Although not shown, it is possible to provide a structure in which the cylindrical directivity-type radiation detecting apparatus as shown in FIGS. 1A and 1B or FIGS. 2A and 2B is installed at a center of a laboratory in a controlled area.

For example, in the case where a cylindrical directivity-type radiation detecting apparatus is installed at a corner of a globe box having a length and width of 1 m, respectively, and a height of 1 m, the detection range requires 90 degrees and the detection height requires 1 m. Accordingly, it is satisfactory to consider three horizontally directional points and three vertically directional points, so that totally nine radiation detector probes are provided in the radiation detecting apparatus. In other example, in the case where it is installed at a center of a controlled area having a length and width of 10 m, respectively, and a height of 2 m, the detection range requires 360 degrees and the detection height requires 2 m. Accordingly, it is satisfactory to consider six horizontally directional points and six vertically directional points, so that totally thirty six radiation detector probes are provided in the radiation detecting apparatus.

By employing the installations described above, it is possible to always remotely monitor the movement of a radioactive substance within a controlsed area. Thus, the directivity-type radiation detecting apparatus of the present invention is not only useful for preventing loss or theft of a radioactive substance but also to be utilized in operation safety control.

One of the advantageous features of the above-described directivity-type radiation detecting apparatus according to the present invention is to detect a movement of a radiation source by dispersedly arranging a multiplicity of radiation detector probes. For example, in the case where the radiation source moves horizontally, the radiation measurement values of the radiation detector probes arranged at horizontally directional points in the same horizontal level on the outer peripheral surface of the cylindrical radiation shield vary sequentially. Also, in the case where the radiation source moves vertically, the radiation measurement values of the radiation detector probes arranged at vertically directional points on the outer peripheral surface of the cylindrical radiation shield vary sequentially. In actual, the horizontal measurement and the vertical measurement are combined. Therefore, the detected values of all the radiation detector probes are measured. The position and the direction of detecting surface of each radiation detector probe and the sensitivity characteristic for the direction are previously known. By considering them and computing and processing in real time measured values by the respective radiation detector probes, it is possible to detect a position of a radiation source and a moving situation.

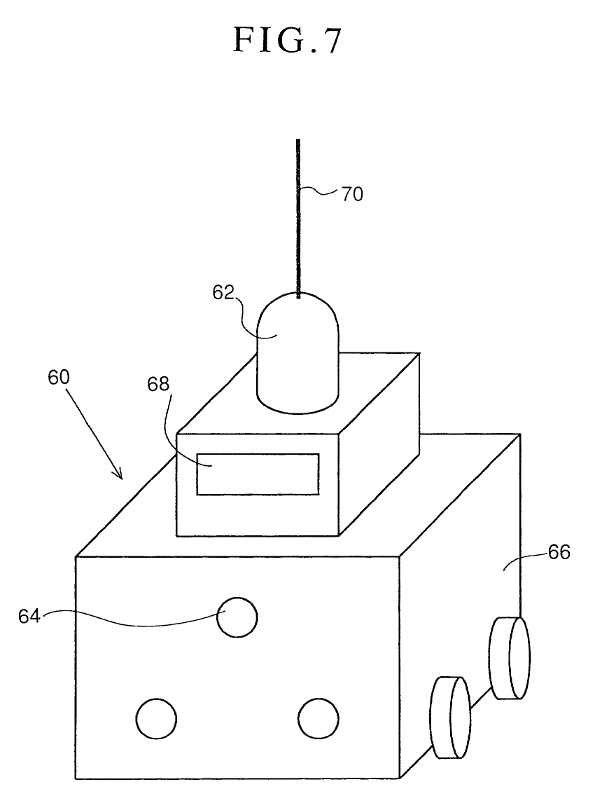

FIG. 7 shows another embodiment of the present invention. This is an example in which the directivity-type radiation detecting apparatus is mounted on a monitor robot. The monitor robot periodically monitors the presence or absence of abnormality within the controlled area, which moves within the controlled area to detect by a space dosimeter whether the measured value of radiation is different from a routine value or not. Therefore, by mounting a semi-spherical directivity-type radiation detecting apparatus 62 on the monitor robot 60, monitor can be conducted more precisely, e.g. facilitating to specify an abnormal location where a dose different from the routine value has been detected. Incidentally, reference numeral 64 is a sensor for confirming safety, 66 a drive section, 68 a data processing/display section and 70 an antenna for transmitting data.

In the directivity-type radiation detecting apparatus of the present invention, by dispersedly arranging a multiplicity of radiation detector probes in different directions, a position and moving situation of a particular radiation source can be detected even in a high radiation atmosphere. Accordingly, even in the case where there are a multiplicity of radiation sources in many directions, a radiation ray coming from a particular radiation source can be easily measured. Abnormal detection can be easily made in operation using a particular radiation source, and abnormal monitor of atmosphere can be made accurately, promptly and particularly. Furthermore, in the case where a radiation source is brought into a high radiation atmosphere, determination of cause can be accurately and promptly made.

Since a movement of a radiation source can be detected in early stage by using the directivity-type radiation detecting apparatus of the present invention, it is possible to detect loss, theft, abnormality during movement of the radiation source to thereby previously prevent against accident and disaster. Also, remote monitor can not only save labor and time but also greatly reduce radiation exposure level.

What is claimed is:

1. A directivity-type radiation detecting apparatus in which a multiplicity of radiation detector probes are dispersedly arranged in different directions on an outer surface of a radiation shield.

2. A directivity-type radiation detecting apparatus in which a multiplicity of penetration holes are dispersedly formed in different directions in a shell-shaped radiation shield and radiation detector probes are respectively disposed in the penetration holes of the radiation shield.

3. A directivity-type radiation detecting apparatus as claimed in claim 1 or 2, wherein the radiation shield has an outer surface in a cylindrical surface form, a spherical surface form or a polygonal cylindrical surface form or has an outer surface of a part thereof.

4. A radiation detecting system in which the directivity-type radiation detecting apparatus as claimed in any of claims 1 to 3 is used to compute and process a position and a direction of each radiation detector probe and a value measured by each radiation detector probe, whereby a position, a distribution situation or a moving situation of a radiation source is detected.
